(19) United States
(12) Patent Application Publication
(10) Pub. No.: US 2014/0196604 A1
(43) Pub. Date: Jul. 17, 2014

(54) Method and Device for Purging Bubbles in the Pipeline of Substrate Coater and Corresponding Substrate Coater

(71) Applicant: Shenzhen China Star Optoelectronics Technology Co., Ltd., Shenzhen (JP)

(72) Inventors: Liang Li, Shenzhen (CN); Chih-Sheng Ko, Shenzhen (CN); Bin Xu, Shenzhen (CN)

(73) Assignee: Shenzhen China Star Optoelectronics Technology Co., Ltd., Shenzhen, Guangdong (CN)

(21) Appl. No.: 13/817,709

(22) PCT Filed: Jan. 15, 2013
(86) PCT No.: PCT/CN2013/070478

§ 371 Date: Feb. 19, 2013

(30) Foreign Application Priority Data
Jan. 11, 2013 (CN) 201310009567.0

(51) Int. Cl. B01D 19/02

(52) U.S. Cl. CPC B01D 19/02
USPC 95/242; 96/176; 137/565.11

(57) ABSTRACT

The present invention provides a method for purging bubbles in the pipeline of a substrate coater, which at least comprises: activating an injection pump for a first time, the injection pump injecting a photoresist into the pipeline of the substrate coater from a storage container; driving the photoresist to flow in the pipeline of the substrate coater and proceeding a purging bubbles process once; closing the injection pump for a second time after finishing the purging bubbles process; and activating the injection pump again and repeating the purging bubbles process until all small bubbles in the pipeline of the substrate coater being purged after the small bubbles in the pipeline of the substrate coater accumulate in the second time. The present invention correspondingly discloses a device for purging bubbles in the pipeline of substrate coater and a substrate coater. According to the embodiment of the present invention, it can improve the purging bubbles efficiency in the pipeline and save the photoresist.

This application claims priority to Chinese Patent Application Serial No. 201310009567.0, named as “method and device for purging bubbles in the pipeline of substrate coater and corresponding substrate coater”, filed on Jan. 11, 2013, the specification of which is incorporated herein by reference.

### BACKGROUND OF THE INVENTION

1. Field of the Invention

The present invention relates to the field of the production process of thin film transistor liquid crystal display (TFT-LCD), and in particular to a method and a device for purging bubbles in the pipeline of substrate coater and a corresponding substrate coater.

2. The Related Arts

In the production process of the TFT-LCD, it needs to process the top substrate and the bottom substrate. The bottom substrate is the process glass of the TFT array, and the top substrate is the process glass of the color filter (CF). The coating process is needed on these two glasses, in which the photoresist is needed to be coated on the two glasses. Because there are more or less bubbles in the pipeline of the coater, it needs to purge bubbles first.

The known purging bubbles process for the pipeline of the coater usually uses purging bubbles repeatedly and purging bubbles in stages. The times of purging bubbles is usually determined by empirical values. These two methods usually can purge the big bubbles, but the small bubbles are usually gathered at the interface of the pipeline system and adhered on the tube wall, which cannot be purged. Therefore, in the known method, the situations of purging bubbles incompletely or needing repeatedly purging bubbles to purge bubbles completely will be happened. In the first situation, if the bubbles in the pipeline are not purged completely, it will result the nonuniform coating effect on the substrate, leading to bad product quality and even failed products. However, dealing with these exceptions will undoubtedly decrease the productivity. In the other situation, if it needs repeatedly purging bubbles process, every purging bubbles process needs the photoresist to flow in the pipeline, resulting in the waste of photoresist.

### SUMMARY OF THE INVENTION

The technical issue to be solved by the present invention is to provide a method and a device for purging bubbles in the pipeline of substrate coater and a corresponding substrate coater, which can improve the utilization efficiency of the photoresist while purging bubbles in the pipeline of substrate coater.

To solve the above technical issue, the embodiment of the present invention provides a device for purging bubbles in the pipeline of a substrate coater, wherein the device for purging bubbles in the pipeline comprises:
an injection pump, which is used to inject a photoresist into the pipeline of the substrate coater from a storage container;
a controlling unit, which is used to activate the injection pump for a first time, driving the photoresist to flow in the pipeline of the substrate coater and proceeding a purging bubbles process once; after finishing the purging bubbles process, closing the injection pump for a second time; and after the small bubbles in the pipeline of the substrate coater accumulate in the second time, activating the injection pump again and repeating the purging bubbles process, until all small bubbles in the pipeline of the substrate coater being purged.

Wherein, the controlling unit further comprises:
an injection pump activated controlling sub-unit, which is used to activate the injection pump for a first time, driving the photoresist to flow in the pipeline of the substrate coater;
an injection pump closed controlling sub-unit, which is used to close the injection pump for a second time after finishing the purging bubbles process once;
a judgment processing sub-unit, which is used to judge if the purging bubbles process is completed or not; if the judging result is that the purging bubbles process is not completed, controlling the injection pump activated controlling sub-unit to reactivate the injection pump after the injection pump closed controlling sub-unit closes the injection pump for the second time.

Wherein, the controlling unit further comprises: a setting sub-unit, which is used to set the values of the first time and the second time.

Wherein, it further comprises: a vibration device, which is used to provide a shock wave for the pipeline of the substrate coater in the second time.

Wherein, the controlling unit further comprises: a vibration controlling sub-unit, which is used to drive the vibration device to provide the shock wave for the pipeline of the substrate coater when the judgment processing sub-unit determines that the purging bubbles process is not completed.

The other technical issue to be solved by the present invention is to provide a substrate coater, which can purge the bubbles in the pipeline, at least comprising a pipeline of the substrate coater, a nozzle connected to the pipeline of the substrate coater, and a device for purging bubbles in the pipeline, wherein the device for purging bubbles in the pipeline comprises: an injection pump, which is used to inject a photoresist into the pipeline of the substrate coater from a storage container; a controlling unit, which is used to activate the injection pump for a first time, driving the photoresist to flow in the pipeline of the substrate coater and proceeding a purging bubbles process once; after finishing the purging bubbles process, closing the injection pump for a second time; and after the small bubbles in the pipeline of the substrate coater accumulate in the second time, activating the injection pump again and repeating the purging bubbles process, until all small bubbles in the pipeline of the substrate coater being purged.

Wherein, the controlling unit further comprises: an injection pump activated controlling sub-unit, which is used to activate the injection pump for a first time, driving the photoresist to flow in the pipeline of the substrate coater; an injection pump closed controlling sub-unit, which is used to close the injection pump for a second time after finishing the purging bubbles process once; a judgment processing sub-unit, which is used to judge if the purging bubbles process is completed or not; if the judging result is that the purging bubbles process is not completed, controlling the injection pump activated controlling sub-unit to reactivate the injection pump after the injection pump closed controlling sub-unit closes the injection pump for the second time.

Wherein, the controlling unit further comprises: a setting sub-unit, which is used to set the values of the first time and the second time.

Wherein, it further comprises: a vibration device, which is used to provide a shock wave for the pipeline of the substrate coater in the second time.

Wherein, the controlling unit further comprises: a vibration controlling sub-unit, which is used to drive the vibration device to provide the shock wave for the pipeline of the substrate coater when the judgment processing sub-unit determines that the purging bubbles process is not completed.

The other technical issue to be solved by the present invention is to provide a method for purging bubbles in the pipeline of a substrate coater, wherein it at least comprises: activating an injection pump for a first time, the injection pump injecting a photoresist into the pipeline of the substrate coater from a storage container; driving the photoresist to flow in the pipeline of the substrate coater and proceeding a purging bubbles process once; closing the injection pump for a second time after finishing the purging bubbles process; and activating the injection pump again and repeating the purging bubbles process until all small bubbles in the pipeline of the substrate coater being purged after the small bubbles in the pipeline of the substrate coater accumulate in the second time.

Wherein, it further comprises: setting the first time and the second time in advance.

Wherein, the purging bubbles process comprises purging bubbles in stages.

Wherein, the specific step of the small bubbles in the pipeline of the substrate coater accumulating in the second time is: standing the pipeline of the substrate coater to allow the small bubbles to accumulate within the second time; or providing a shock wave for the pipeline of the substrate coater to allow the small bubbles to accumulate within the second time.

The embodiment according to the present invention has the beneficial effects as follows.

In the embodiment of the present invention, add an interval setting of a second time after the purging bubbles process once, so that the small bubbles can be accumulated to be large bubbles in this timing interval. After that, proceed the purging bubbles process, which can improve the efficiency of purging bubbles with the same using amount of the photoresist, so that the bubbles in the pipeline of the substrate coater can be purged completely. The photoresist can be saved and the utilization thereof can also be improved.

### BRIEF DESCRIPTION OF THE DRAWINGS

To illustrate clearly the technical solution of the embodiments according to the present invention, a brief description of the drawings that are necessary for the illustration of the embodiments will be given as follows. Apparently, the drawings described below show only example embodiments of the present invention and for those having ordinary skills in the art, other drawings may be easily obtained from these drawings without paying any creative effort.

FIG. 1 is a schematic view illustrating a substrate coater according to the first embodiment of the present invention;

FIG. 2 is a schematic view illustrating the structure of the controlling unit shown in FIG. 1;

FIG. 3 is a schematic view illustrating a substrate coater according to the second embodiment of the present invention;

FIG. 4 is a schematic view illustrating the structure of the controlling unit shown in FIG. 3;

FIG. 5 is a flow chart of the method for purging bubbles in the pipeline of substrate coater according to one embodiment of the present invention; and

FIG. 6 is a schematic view illustrating the period of repeatedly purging bubbles process according to the present invention.

### DETAILED DESCRIPTION OF THE PREFERRED EMBODIMENTS

The detailed descriptions accompanying drawings and the preferred embodiment of the present invention are as follows.

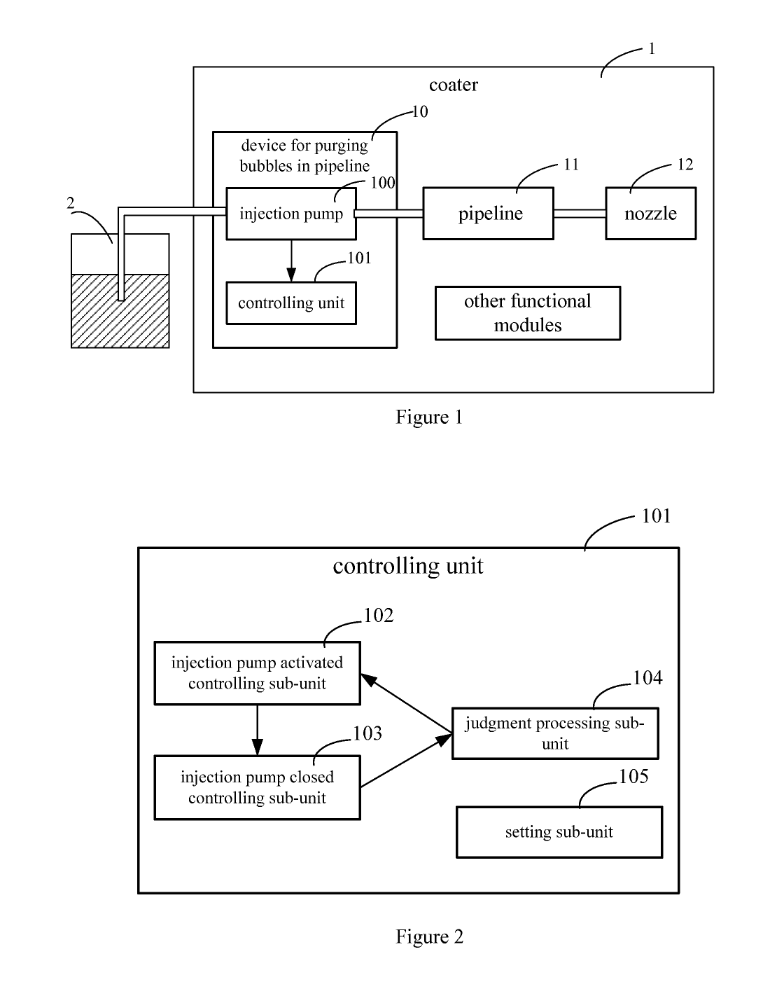

Referring to FIGS. 1 and 2, it shows the schematic structure of a substrate coater according to the first embodiment of the present invention. It can be seen that the substrate coater 1 at least comprises:
a pipeline 11, which is provided for photoresist passing through, wherein the bubbles will remain for various reasons;
a nozzle 12, which is provided at the end of the pipeline 11 and used to uniformly spray the photoresist on the desired glass substrate;
a device for purging bubbles in pipeline 10, which is conncected to the pipeline 11, used to purging bubbles for the pipeline 11, comprising:
an injection pump 100, which is used to inject a photoresist into the pipeline 11 of the substrate coater 1 from a storage container 2;
a controlling unit 101, which is used to activate the injection pump for a first time, driving the photoresist to flow in the pipeline of the substrate coater and proceeding a purging bubbles process once; after finishing the purging bubbles process, closing the injection pump for a second time; and after the small bubbles in the pipeline of the substrate coater accumulate in the second time, activating the injection pump again and repeating the purging bubbles process, until all small bubbles in the pipeline of the substrate coater being purged.

Wherein, the controlling unit 101 further comprises:
an injection pump activated controlling sub-unit 102, which is used to activate the injection pump 100 for a first time, driving the photoresist to flow in the pipeline of the substrate coater;
an injection pump closed controlling sub-unit 103, which is used to close the injection pump 100 for a second time after finishing the purging bubbles process once;
a judgment processing sub-unit 104, which is used to judge if the purging bubbles process is completed or not; if the judging result is that the purging bubbles process is not completed, controlling the injection pump activated controlling sub-unit 102 to reactivate the injection pump 100 after the injection pump closed controlling sub-unit 103 closes the injection pump 100 for the second time;
a setting sub-unit 105, which is used to set the values of the first time and the second time.

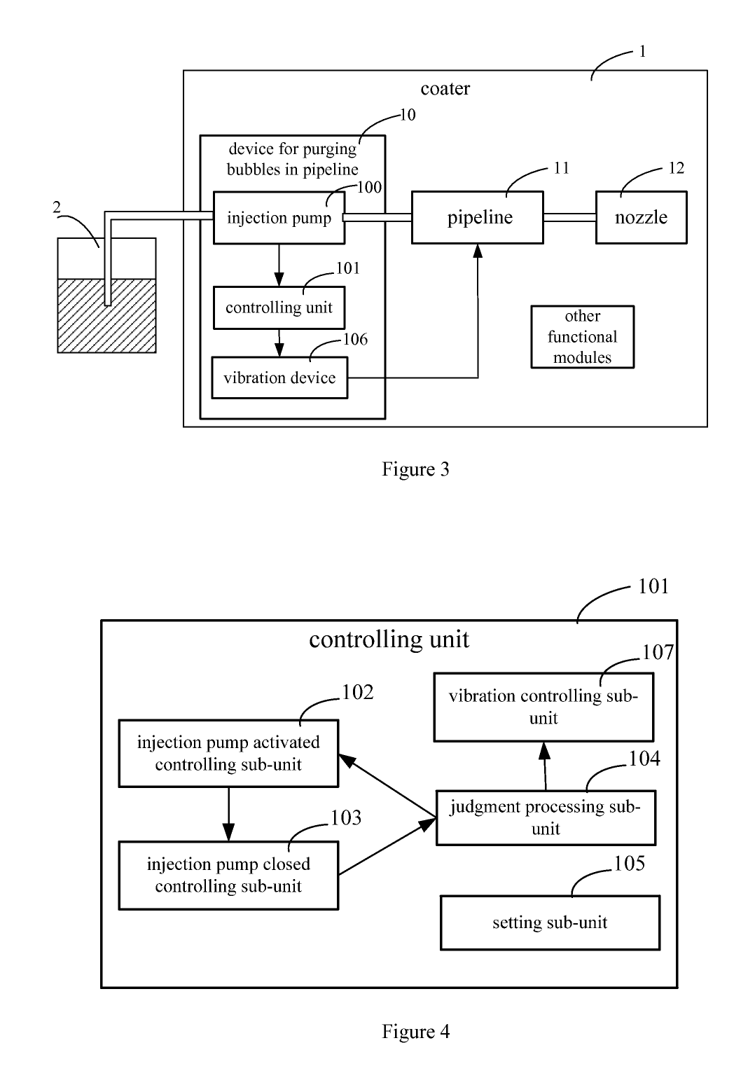

Referring to FIG. 3 and FIG. 4, it shows the schematic structure of a substrate coater according to the second embodiment of the present invention. Comparing with the first embodiment shown in FIGS. 1 and 2, it can be seen that the difference in the substrate coater according to the second embodiment is that the device for purging bubbles in pipeline 10 further comprises: a vibration device 106, which is used to provide a shock wave for the pipeline 11 of the substrate coater in the second time to accelerate the aggregation of small bubbles in the pipeline 11. In a embodiment, the shock wave can be ultrasonic.

Correspondingly, the controlling unit 101 further comprises: a vibration controlling sub-unit 107, which is used to drive the vibration device 106 to provide the shock wave for the pipeline 11 of the substrate coater when the judgment processing sub-unit 104 determines that the purging bubbles process is not completed.

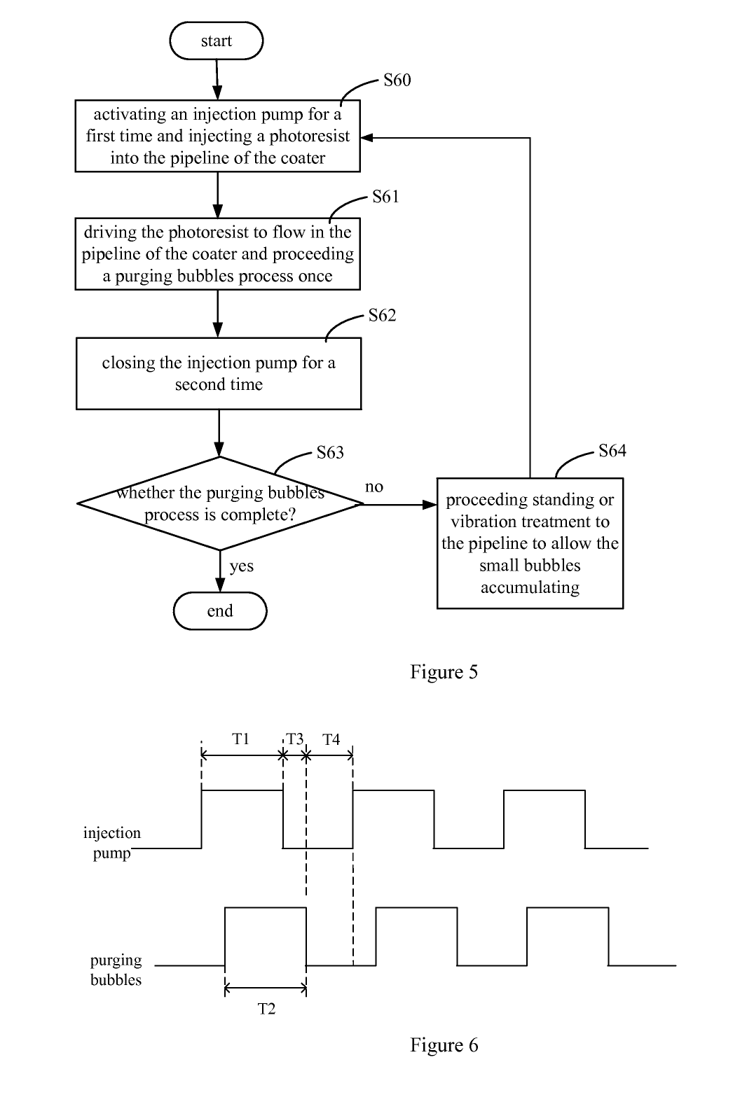

As shown in FIG. 5, it shows a flow chart of the method for purging bubbles in the pipeline of substrate coater according to one embodiment of the present invention. It can be seen that the method at least comprises the following steps:
step S60, activating an injection pump for a first time, the injection pump injecting a photoresist into the pipeline of the substrate coater from a storage container;
step S61, driving the photoresist to flow in the pipeline of the substrate coater and proceeding a purging bubbles process once;
step S62, closing the injection pump for a second time after finishing the purging bubbles process;
step S63, judging whether the purging bubbles process is complete, if the judged result is positive, end the process; if the judged result is negative, proceed to step S64;
step S64, allowing the small bubbles in the pipeline of the substrate coater accumulating in the second time, specifically, standing the pipeline of the substrate coater to allow the small bubbles to accumulate within the second time; or providing a shock wave for the pipeline of the substrate coater to allow the small bubbles to accumulate within the second time.

Jump to step S60, activating the injection pump again and repeating the purging bubbles process until all small bubbles in the pipeline of the substrate coater are purged after the small bubbles in the pipeline of the substrate coater accumulate in the second time.

It can be understood that it needs to set the first time and the second time in advance.

As shown in FIG. 6, it is a schematic view illustrating the period of repeatedly purging bubbles process according to the present invention. In an embodiment, assume that repeatedly purging bubbles process is needed for the pipeline of the substrate coater. In the cycle diagram of the activating time of the injection pump, the high segment represents injection pump activated, and the low segment represents injection pump closed. In the cycle diagram of the activating time of the injection pump, the high segment represents that the purging bubbles process is in progress, and the low segment represents that the purging bubbles process is stopped.

Wherein, time T1 represents single activating time for the injection pump; time T2 represents the time for purging bubbles once for the pipeline of the substrate coater, in which there is a certain timing difference between the stating time and the starting activating time of the injection pump; time T3 represents the delay time between completing activating the injection pump and completing purging bubbles once for the pipeline, time T4 represents the new timing interval between two purging bubbles process (that is the second time mentioned above). In the new timing interval, by standing the pipeline of the substrate coater or providing a shock wave for the pipeline of the substrate coater, it allows the small bubbles remaining in the pipeline having time to accumulate and enlarge the volume. In the next purging bubbles process, the success rate of purging bubbles can be increased.

The embodiment according to the present invention has the beneficial effects as follows.

In the embodiment of the present invention, add an interval setting of a second time after the purging bubbles process once, so that the small bubbles can be accumulated to be large bubbles in this timing interval. After that, proceed the purging bubbles process, which can improve the efficiency of purging bubbles with the same using amount of the photoresist, so that the bubbles in the pipeline of the substrate coater can be purged completely. The photoresist can be saved and the utilization thereof can also be improved.

The preferred embodiments of the present invention have been described, but not intending to impose any unduly constraint to the appended claims. Any modification of equivalent change is considered encompassed in the scope of protection defined by the clams of the present invention.

What is claimed is:

1. A device for purging bubbles in the pipeline of a substrate coater, wherein the device for purging bubbles in the pipeline comprises:
an injection pump, which is used to inject a photoresist into the pipeline of the substrate coater from a storage container;
a controlling unit, which is used to activate the injection pump for a first time, driving the photoresist to flow in the pipeline of the substrate coater and proceeding a purging bubbles process once; after finishing the purging bubbles process, closing the injection pump for a second time;
and after the small bubbles in the pipeline of the substrate coater accumulate in the second time, activating the injection pump again and repeating the purging bubbles process, until all small bubbles in the pipeline of the substrate coater being purged.

2. The device for purging bubbles in the pipeline as claimed in claim 1, wherein the controlling unit further comprises:
an injection pump activated controlling sub-unit, which is used to activate the injection pump for a first time, driving the photoresist to flow in the pipeline of the substrate coater;
an injection pump closed controlling sub-unit, which is used to close the injection pump for a second time after finishing the purging bubbles process once;
a judgment processing sub-unit, which is used to judge if the purging bubbles process is completed or not; if the judging result is that the purging bubbles process is not completed, controlling the injection pump activated controlling sub-unit to reactivate the injection pump after the injection pump closed controlling sub-unit closes the injection pump for the second time.

3. The device for purging bubbles in the pipeline as claimed in claim 2, wherein it further comprises:
a vibration device, which is used to provide a shock wave for the pipeline of the substrate coater in the second time.

4. The device for purging bubbles in the pipeline as claimed in claim 3, wherein the controlling unit further comprises:
a vibration controlling sub-unit, which is used to drive the vibration device to provide the shock wave for the pipeline of the substrate coater when the judgment processing sub-unit determines that the purging bubbles process is not completed.

5. The device for purging bubbles in the pipeline as claimed in claim 4, wherein the controlling unit further comprises:
a setting sub-unit, which is used to set the values of the first time and the second time.

6. A substrate coater, which can purge the bubbles in the pipeline, at least comprising a pipeline of the substrate coater, a nozzle connected to the pipeline of the substrate coater, and a device for purging bubbles in the pipeline, wherein the device for purging bubbles in the pipeline comprises:
an injection pump, which is used to inject a photoresist into the pipeline of the substrate coater from a storage container;
a controlling unit, which is used to activate the injection pump for a first time, driving the photoresist to flow in the pipeline of the substrate coater and proceeding a purging bubbles process once; after finishing the purging bubbles process, closing the injection pump for a second time;
and after the small bubbles in the pipeline of the substrate coater accumulate in the second time, activating the injection pump again and repeating the purging bubbles process, until all small bubbles in the pipeline of the substrate coater being purged.

7. The substrate coater as claimed in claim 6, wherein the controlling unit further comprises:
an injection pump activated controlling sub-unit, which is used to activate the injection pump for a first time, driving the photoresist to flow in the pipeline of the substrate coater;
an injection pump closed controlling sub-unit, which is used to close the injection pump for a second time after finishing the purging bubbles process once;
a judgment processing sub-unit, which is used to judge if the purging bubbles process is completed or not; if the judging result is that the purging bubbles process is not completed, controlling the injection pump activated controlling sub-unit to reactivate the injection pump after the injection pump closed controlling sub-unit closes the injection pump for the second time.

8. The substrate coater as claimed in claim 7, wherein the controlling unit further comprises:
a setting sub-unit, which is used to set the values of the first time and the second time.

9. The substrate coater as claimed in claim 8, wherein it further comprises:
a vibration device, which is used to provide a shock wave for the pipeline of the substrate coater in the second time.

10. The substrate coater as claimed in claim 9, wherein the controlling unit further comprises:
a vibration controlling sub-unit, which is used to drive the vibration device to provide the shock wave for the pipeline of the substrate coater when the judgment processing sub-unit determines that the purging bubbles process is not completed.

11. A method for purging bubbles in the pipeline of a substrate coater, wherein it at least comprises:
activating an injection pump for a first time, the injection pump injecting a photoresist into the pipeline of the substrate coater from a storage container;
driving the photoresist to flow in the pipeline of the substrate coater and proceeding a purging bubbles process once;
closing the injection pump for a second time after finishing the purging bubbles process; and
activating the injection pump again and repeating the purging bubbles process until all small bubbles in the pipeline of the substrate coater are purged after the small bubbles in the pipeline of the substrate coater accumulate in the second time.

12. The method for purging bubbles in the pipeline as claimed in claim 11, wherein it further comprises:
setting the first time and the second time in advance.

13. The method for purging bubbles in the pipeline as claimed in claim 12, wherein the purging bubbles process comprises purging bubbles in stages.

14. The method for purging bubbles in the pipeline as claimed in claim 11, wherein the specific step of the small bubbles in the pipeline of the substrate coater accumulating in the second time is:
standing the pipeline of the substrate coater to allow the small bubbles to accumulate within the second time; or providing a shock wave for the pipeline of the substrate coater to allow the small bubbles to accumulate within the second time.

15. The method for purging bubbles in the pipeline as claimed in claim 12, wherein the specific step of the small bubbles in the pipeline of the substrate coater accumulating in the second time is:
standing the pipeline of the substrate coater to allow the small bubbles to accumulate within the second time; or
providing a shock wave for the pipeline of the substrate coater to allow the small bubbles to accumulate within the second time.

16. The method for purging bubbles in the pipeline as claimed in claim 13, wherein the specific step of the small bubbles in the pipeline of the substrate coater accumulating in the second time is:
standing the pipeline of the substrate coater to allow the small bubbles to accumulate within the second time; or
providing a shock wave for the pipeline of the substrate coater to allow the small bubbles to accumulate within the second time.
